(19) United States
(12) Patent Application Publication
(10) Pub. No.: US 2016/0259920 A1
(43) Pub. Date: Sep. 8, 2016

(54) INFORMATION PROCESSING SYSTEM, INFORMATION PROCESSING METHOD, AND NON-TRANSITORY COMPUTER READABLE MEDIUM

(71) Applicant: FUJI XEROX CO., LTD., Tokyo (JP)

(72) Inventor: Taro TERAO, Kanagawa (JP)

(73) Assignee: FUJI XEROX CO., LTD., Tokyo (JP)

(21) Appl. No.: 14/809,963

(22) Filed: Jul. 27, 2015

(30) Foreign Application Priority Data
Mar. 6, 2015 (JP) 2015-044654

(51) Int. Cl. G06F 21/10; H04L 29/08; H04L 29/06

(52) U.S. Cl. CPC G06F 21/10; H04L 63/08; H04L 67/02; H04L 63/10

(57) ABSTRACT

An information processing system includes a management unit, an accepting unit, and a providing unit. The management unit manages information on an object whose parent or child is defined. The accepting unit accepts a reading request for a to-be-provided object managed by the management unit, the request including designation of an authority object with which authority information is associated. The providing unit provides information on the to-be-provided object, on the basis of a result of comparison of authority between an owner object that is an object approving the authority information and an object that is a parent of the authority object. The providing unit provides, for a data item not included in the to-be-provided object, information on a data item of an ancestor object included in a series that recursively traces a parent of the to-be-provided object and further a parent thereof.

### CROSS-REFERENCE TO RELATED APPLICATIONS

This application is based on and claims priority under 35 USC 119 from Japanese Patent Application No. 2015-044654 filed Mar. 6, 2015.

### BACKGROUND

### Technical Field

The present invention relates to an information processing system, an information processing apparatus, and a non-transitory computer readable medium.

### SUMMARY

According to an aspect of the invention, there is provided an information processing system including a management unit, an accepting unit, and a providing unit. The management unit manages information on an object of which at least one of a parent and a child is defined. The accepting unit accepts a reading request for a to-be-provided object managed by the management unit, the request including designation of an authority object that is an object with which authority information is associated. The providing unit provides information on the to-be-provided object, on the basis of a result of comparison of authority between an owner object that is an object approving the authority information and an object that is a parent of the authority object. The providing unit provides, for a data item not included in the to-be-provided object, information on a data item of an ancestor object included in a series that recursively traces a parent of the to-be-provided object and further a parent thereof.

### BRIEF DESCRIPTION OF THE DRAWINGS

An exemplary embodiment of the present invention will be described in detail based on the following figures, wherein:

FIG. 1 is a system configuration diagram of an information processing system according to an exemplary embodiment of the present invention;

FIG. 2 is a functional block diagram of a server;

FIG. 3 is a diagram illustrating a specific example of prototype-based objects;

FIG. 4 is a diagram illustrating an example of an object management table;

FIG. 5 is a diagram illustrating an example of a value management table;

FIG. 6 is a sequence diagram of a distribution access token creating process;

FIG. 7 is a sequence diagram of a distribution object content displaying process;

FIG. 8 is a sequence diagram of a distribution object invalidating process;

FIG. 9 is a sequence diagram of a distribution object invalidating process;

FIG. 10 is a sequence diagram of a distribution object freezing process;

FIG. 11 is a sequence diagram of a process of adding an arbitrary function to a distribution object;

FIG. 12 is a sequence diagram of a process of displaying content of a distribution object to which authentication is added;

FIG. 13 is a diagram illustrating an exemplary configuration of objects;

FIG. 14 is a diagram illustrating an exemplary configuration of objects; and

FIG. 15 is a diagram illustrating an exemplary configuration of objects.

### DETAILED DESCRIPTION

An exemplary embodiment for implementing the present invention (hereinafter referred to as an exemplary embodiment) will be described below on the basis of the drawings.

### 1. Description of System Configuration

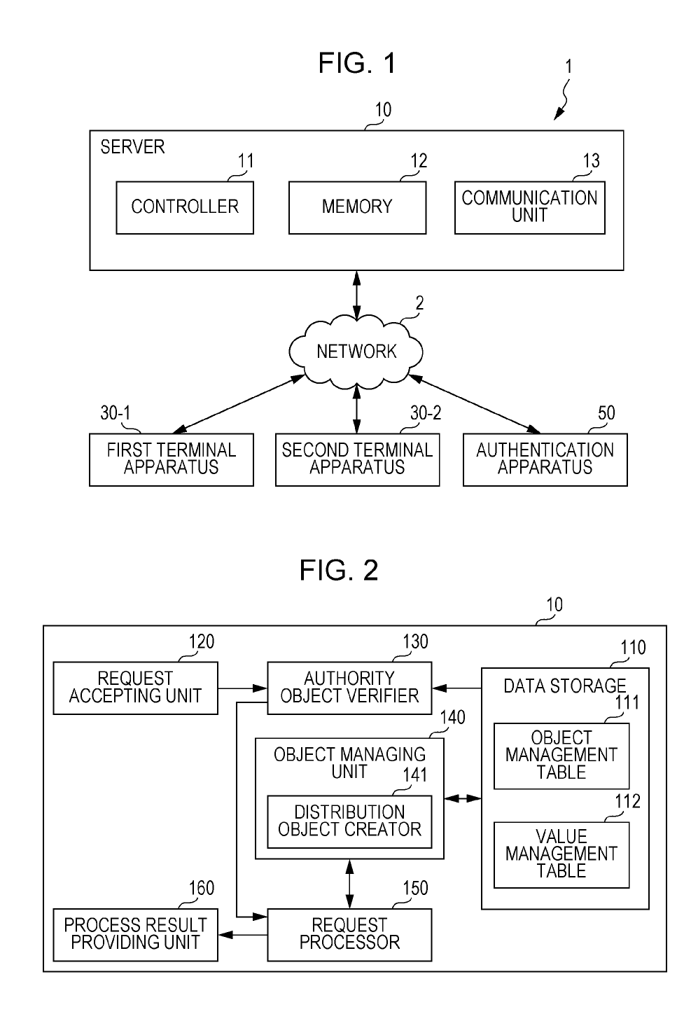

FIG. 1 illustrates an exemplary system configuration of an image processing system S according to the exemplary embodiment. As illustrated in FIG. 1, the image processing system S includes a server 10, a first terminal apparatus 30-1, a second terminal apparatus 30-2, and an authentication apparatus 50. The server 10 is connected to the first terminal apparatuses, the second terminal apparatus 30-2, and the authentication apparatus 50 so as to be able to communicate data via a network 2. In the following description, the first terminal apparatus 30-1 and the second terminal apparatus 30-2 may be represented as a terminal apparatus 30 for details that are common in both of the terminal apparatuses 30-1 and 30-2.

As illustrated in FIG. 1, the server 10 includes a controller 11, a memory 12, and a communication unit 13, which serve as examples of hardware configuration.

The controller 11 includes a central processing unit (CPU). The controller 11 executes various arithmetic operation processes and controls each unit of the server 10 on the basis of a program stored in the memory 12.

The memory 12 stores a control program such as an operating system of the server 10, and data. The memory 12 is also used as a work memory for the controller 11. A program may be supplied to the server 10 while being stored in an information storage medium such as an optical disk, a magnetic disk, a magnetic tape, a magneto-optical disk, or a flash memory, or may be provided to the server 10 via a data communication network such as the Internet.

The communication unit 13 includes, for example, a network interface card (NIC), and the communication unit 13 connects to the network 2 via the NIC and communicates with the terminal apparatus 30 or the like connected to the network 2.

In the exemplary embodiment, the server 10 manages prototype-based objects. Here, a prototype-based object is an object that has an object (prototype) that serves as the only parent, except for the only root object existing in a set of prototype-based objects. Note that the root object does not have its prototype.

When an object A is the prototype of an object B, it is said that the object B is the artifact of the object A. Depending on the prototype relationship between objects, a set of all prototype-based objects is represented as a tree structure. Also, as long as the tree structure constructed by objects is not destroyed, the tree structure may be transformed by re-connecting prototypes.

Further, an object managed by the server 10 may have a property and a property value. In a representational state transfer (REST) architecture style, an object may be referred to as a resource, and a value may be referred to as a representation. Objects may include an object that simply has an object identifier and a prototype and that only represents a pure identity, an object that represents data with an arbitrary content-type value, and an object that represents an entity such as an access token that is a credential proving an access right, or an application (client) that accesses a resource owner who is the owner of the object or accesses the object when approval is given from the resource owner. These objects are included in one tree structure. Note that it may also be said that the above-mentioned access token is an object with which authority information is associated.

In the image processing system S according to the exemplary embodiment, the server 10 accepts a request presenting an access token, and, in the case where the access token is verified as valid, processes the accepted request within the range of authority identified on the basis of the access token. For example, the range of authority identified by the access token is approval (or disapproval) of any of creating (adding) an object, referring to, updating, and deleting the details, and so forth. In addition, for example, in accordance with an accepted request from the terminal apparatus 30, the server 10 executes addition or updating of a managed object, reading of information, or deletion of information.

In the image processing system S according to the exemplary embodiment, it is assumed that the server 10 manages content that is master data for distribution, which is created on the basis of a request from the first terminal apparatus 30-1. On the basis of the request from the first terminal apparatus 30-1, the server 10 creates an object that is a child of the content, which is the master data. The first terminal apparatus 30-1 distributes to the second terminal apparatus 30-2 information on the object, which is a child of the master data, instead of the master data itself. It is possible to individually add, update, or delete the details of the object, which is a child of the master data, and such addition, updating, or deletion of the details does not affect the details of the master data, which is the parent.

In the following description, an example of functions included in the server 10 in order to implement the above processing will be described in detail.

### 2. Description of Functions Included in Server 10

Next, an example of functions included in the server 10 will be described on the basis of a functional block diagram of the server 10 illustrated in FIG. 2. As illustrated in FIG. 2, the server 10 includes a data storage 110, a request accepting unit 120, an authority object verifier 130, an object management unit 140, a request processor 150, and a process result providing unit 160.

The above-mentioned functions included in the server 10 may be implemented by reading and executing, by the controller 11 included in the server 10, a program stored in the memory 12 or a computer-readable information storage medium. Note that the program may be supplied to the server 10 through an information storage medium such as an optical disk, a magnetic disk, a magnetic tape, a magneto-optical disk, or a flash memory, or may be provided to the server 10 via a data communication network such as the Internet. Hereinafter, the functions included in the server 10 will be described in detail.

The data storage 110 manages information on prototype-based objects. Here, prototype-based objects include an authority object referred to as an access token with which authority information is associated. A prototype-based object is a changeable (mutable) object and is typically identified by a randomly generated identification (ID).

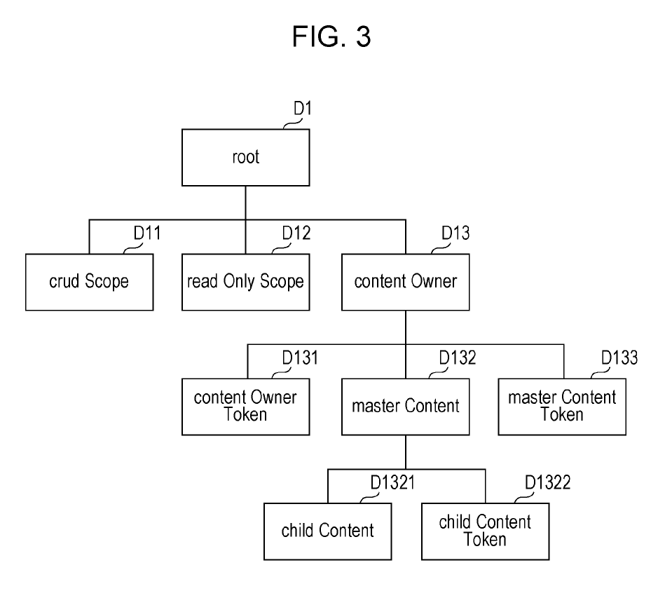

FIG. 3 illustrates a specific example of a prototype-based object group managed by the server 10. In the example illustrated in FIG. 3, each node represents an object, and each edge connecting nodes represents a parent-child relationship based on prototype inheritance.

As illustrated in FIG. 3, a “root” object D1 has, as child objects, a “crud Scope” object D11, a “read Only Scope” object D12, and a “content Owner” object D13. Further, the “content Owner” object D13 has, as child objects, a “content Owner Token” object D131, a “master Content” object D132, and a “master Content Token” object D133. Further, the “master Content” object D132 has, as child objects, a “child Content” object D1321, and a “child Content Token” object D1322.

In the example illustrated in FIG. 3, the “crud Scope” object D11 corresponds to the scope of approving the range of CRUD (Create, Read, Update, and Delete), and the “read Only Scope” object D12 corresponds to the scope of approving only reading.

Further, the “content Owner” object D13 corresponds to the owner of the “master Content” object D132. The “content Owner Token” object D131 corresponds to a token for the “content Owner” object D13 to perform CRUD, which is a token that has “content Owner” as the owner, “content Owner” as the client (authority delegation destination), and “crud Scope” as the scope.

Further, the “master Content” object D132 corresponds to master data, and the “master Content Token” object D133 corresponds to a token for creating a child of the master data. Note that the “master Content Token” object D133 is a token that has “master Content” as the owner, “master Content” as the client (authority delegation destination), and “crud Scope” as the scope.

Further, the “child Content” object D1321 corresponds to a child object for distribution, and the “child Content Token” object D1322 corresponds to a token for updating the “child Content” object D1321. Note that the “child Content” object D1321 is a token that has “master Content” as the owner, “child Content” as the client (authority delegation destination), and “crud Scope” as the scope.

In the exemplary embodiment, the data storage 110 includes an object management table 111 and a value management table 112, and stores and manages information on prototype-based objects in the object management table 111 and the value management table 112.

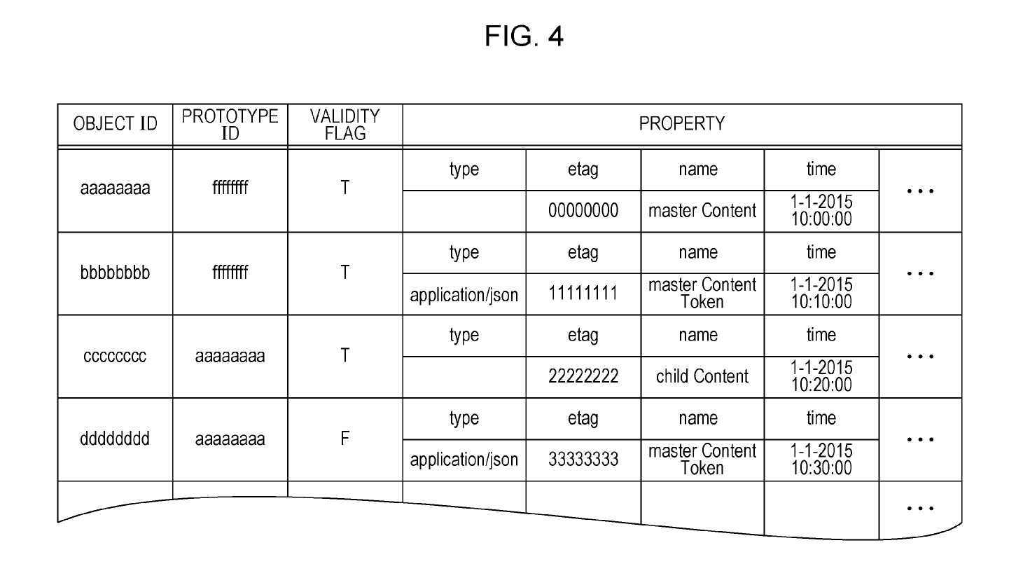

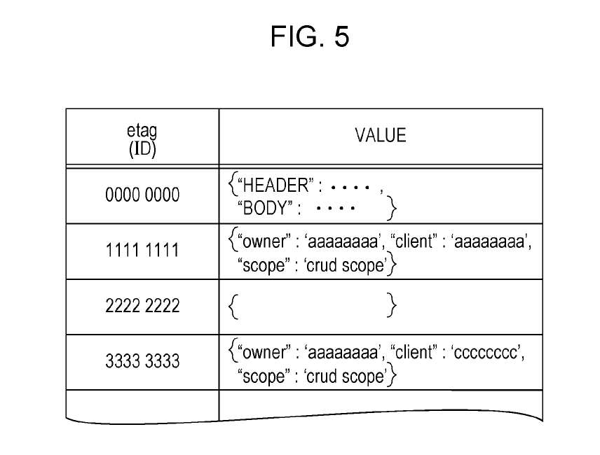

FIG. 4 illustrates an example of the object management table 111, and FIG. 5 illustrates an example of the value management table 112.

As illustrated in FIG. 4, the object management table 111 stores an object ID, which is identification information of a prototype-based object, a prototype ID, which is identification information of the parent (prototype) object of the object, a validity flag indicating whether the object is validated or not (T: valid, F: invalid), and property information of the object in association with one another. In addition, the property information of the object includes “type” indicating the type of the object, “etag” representing identification information of a data object storing the data details of the object, “name” storing the name of the object, and “time” representing the object's creation date and time. Note that the data configuration of a prototype-based object is not limited to the example illustrated in FIG. 4, and may include elements other than the above-described elements. Whether an object is valid or not may be treated as property information representing the invalidation date and time, instead of using the flag. In that case, for the sake of prototype inheritance, invalidating a certain node causes all nodes of a subtree having the certain node as the root to be collectivity invalidated.

In addition, as illustrated in FIG. 5, the value management table 112 associates a value with etag. For example, a value may be an arbitrary octet string, and an etag value may be a hash value of that octet string.

For example, when an object corresponds to content, information on each item, such as “header” and body”, is stored as an etag value. In addition, for example, regarding content in which a first object serves as a parent and a second object serves as a child of the first object, in the case where information is stored in “header” and “body” as etag values of the first object, whereas no information is stored in “header” and “body” as etag values of the second object, if reference is made to the content of the second object, the information stored in “header” and “body” of the first object is used as the content of the second object. In addition, if there is information stored in “header” and “body” in the content of the second object, the stored information is used as the content of the second object.

In addition, for example, when an object is an access token, information in the format {“owner”: the object ID of the owner, “client”: the object ID of the client, “scope”: the range of approved processing} is included as etag values. In the image processing system S according to the exemplary embodiment, an access token is appended to a processing request accepted from the terminal apparatus 30; here, information on the owner, client, and scope is identified by verifying the access token. Note that the owner is treated as the requester of processing, and the client is treated as a proxy requester of processing.

The request accepting unit 120 accepts a request from the terminal apparatus 30. For example, the request accepting unit 120 may accept, from the terminal apparatus 30, a request regarding processing of an object managed by the data storage 110. Note that the request accepting unit 120 may accept, together with a request from the terminal apparatus 30, information on an access token regarding the request. At this time, the request accepting unit 120 may accept a request in the form of, for example, an Hypertext Transfer Protocol (HTTP) request from the terminal apparatus 30.

The authority object verifier 130 obtains information on an authority object (access token) regarding a request accepted by the request accepting unit 120, and verifies the obtained authority object. For example, an authority information obtainer may obtain information on an access token from an authorization field of an HTTP request, or, if there is a cookie including information on an access token, may obtain the information from the cookie.

The authority object verifier 130 verifies whether the above-obtained information on the access token (authority object) is valid. Hereinafter, a specific example of a verification process performed by the authority object verifier 130 will be described.

First, the authority object verifier 130 determines whether the ID of an access token obtained by the authority information obtainer is included in the object management table 111 managed by the data storage 110 (whether a first condition is satisfied), and, if the ID is not included, determines that the verification has failed.

Next, in the case where the first condition is satisfied, the authority object verifier 130 determines whether the data format (type) of the access token is a certain type (that is, application/json) (whether a second condition is satisfied), and, if the data format (type) is not the certain type, determines that the verification has failed. That is, for etag of the access token, in the case where a value stored in the value management table 112 is not a certain type (data format specifying owner, client, and scope), it is determined that the verification has failed.

Next, in the case where the second condition is satisfied, the authority object verifier 130 obtains the values of the access token (the values of the owner, client, and scope) and determines whether the values of the owner, client, and scope are data managed by the data storage 110 (whether a third condition is satisfied), and, in the case where any of the values is not data managed by the data storage 110, the authority object verifier 130 determines that the verification has failed.

Next, in the case where the third condition is satisfied, the authority object verifier 130 obtains information on the prototype of the access token from the data storage 110, determines whether the prototype of the access token matches the owner of the access token or whether the prototype of the access token is included in a prototype chain of the owner (a path that sequentially connects ancestors of the owner including the parent of the owner and further the parent thereof) (whether a fourth condition is satisfied), and, if none of the above is the case, the authority object verifier 130 determines that the verification has failed. In addition, the above-mentioned prototype chain may also be referred to as a series that recursively traces the parent of the object and further the parent thereof. Note that, in the case where the first to fourth conditions are satisfied, the authority object verifier 130 may determine that the access token has been successfully verified.

The authority object verifier 130 notifies the request processor 150 of the result of above-described verification, information on the scope (the range of processing) approved by the access token, and the accepted request.

The request processor 150 controls processing of the request accepted by the request accepting unit 120, on the basis of the verification result, reported from the authority object verifier 130, regarding the access token (authority object) obtained for the request accepted by the request accepting unit 120, and the scope (range of processing) approved for the accepted access token. For example, in the case where the result of verification of the access token regarding the request accepted by the request accepting unit 120 is a verification failure, the request processor 150 may not accept processing regarding the request and may output an error to the process result providing unit 160. In addition, in the case where the result of verification of the access token regarding the request accepted by the request accepting unit 120 is a successful verification, the request processor 150 processes the request accepted by the request accepting unit 120 on the basis of the scope approved for the access token accepted regarding the request, and outputs the execution result to the process result providing unit 160.

For example, the request processor 150 may request the object management unit 140 to create, read, update, or delete an object on the basis of the accepted request, and receives a process result from the object management unit 140.

Specifically, in the case where the accepted request is creation of a distribution object regarding master data, the request processor 150 may request the object management unit 140 to create a child object (or a descendant object) of the master data (object), and may transmit the object ID of the created child object (or descendant object) as a process result to the terminal apparatus 30 via the process result providing unit 160.

The object management unit 140 manages information on objects managed by the data storage 110. For example, on the basis of a request accepted from the request processor 150, the object management unit 140 executes processing such as addition, reading, updating, or deleting of information from the object management table 111 and/or the value management table 112.

In addition, the object management unit 140 includes a distribution object creating unit 141, and creates a distribution object that is a child (or a descendant) of master data on the basis of a distribution object creating request accepted from the request processor 150.

In addition, the object management unit 140 reads information on a distribution object, on the basis of a distribution object reading request accepted from the request processor 150. Here, for a data item not included in the distribution object, the object management unit 140 refers to information on a data item of the parent (or ancestor) object of the distribution object and returns this information as information on the distribution object.

In addition, the object management unit 140 updates details of a distribution object, on the basis of a distribution object updating request accepted from the request processor 150. In addition, the object management unit 140 deletes a distribution object, on the basis of a distribution object deleting request accepted from the request processor 150.

The process result providing unit 160 provides the terminal apparatus 30, which is the sender of a request, with a process result obtained by the request processor 150. For example, in the case where a process request accepted by the request accepting unit 120 is creation of a distribution object, the process result providing unit 160 may provide the terminal apparatus 30 with the object ID of the created distribution object. For example, in the case where a process request accepted by the request accepting unit 120 is reading of a distribution object, the process result providing unit 160 may provide the terminal apparatus 30 with information on the read distribution object (that is, content data). For example, in the case where a process request accepted by the request accepting unit 120 is updating or deletion of a distribution object, the process result providing unit 160 may provide the terminal apparatus 30 with information indicating whether updating or deletion of the distribution object is successful.

### 3. Description of Exemplary Processes

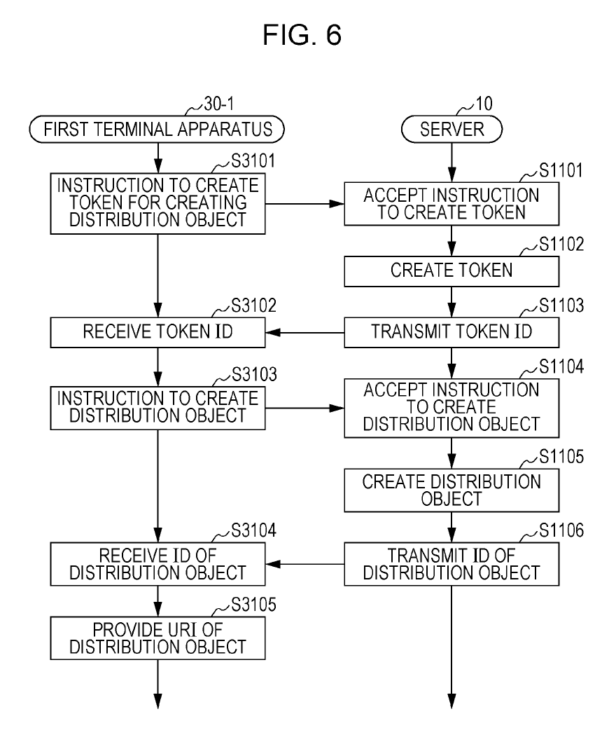

Next, an example of processing executed by the image processing system S will be described in detail on the basis of the sequence diagrams illustrated in FIGS. 6 to 12.

### 3.1. Distribution Object Creating Process

First, on the basis of the sequence diagram illustrated in FIG. 6, an example of a distribution object access token creating process executed by the first terminal apparatus 30-1 and the server 10 will be described. First, in the flow of FIG. 6, the first terminal apparatus 30-1 has an access token T1 (content Owner token) defining the scope of approval of creation, obtaining, updating, and deletion of a child object of a parent object (content Owner) of master data (master Content).

As illustrated in FIG. 6, using the access token T1, the first terminal apparatus 30-1 gives an instruction to the server 10 to create an access token T2 (master Content Token) for creating a child object of the master data (master Content) (S3101).

Upon acceptance of the instruction from the first terminal apparatus 30-1 to create the access token T2 (S1101), the server 10 verifies the access token T1, and, in the case of a successful verification, creates the access token T2 (S1102). The server 10 transmits the ID (object ID) of the created access token T2 to the first terminal apparatus 30-1 (S1103).

The first terminal apparatus 30-1 receives the ID of the access token T2, transmitted from the server 10 (S3102).

Next, using the access token T2, the first terminal apparatus 30-1 gives an instruction to the server 10 to create a child object of the master data as a distribution object of the master data (S3103).

Upon acceptance of the instruction from the first terminal apparatus 30-1 to create the distribution object (S1104), the server 10 verifies the access token T2, and, in the case of a successful verification, creates the distribution object, that is, a child object of the master data (S1105). The server 10 transmits the ID (object ID) of the created distribution object to the first terminal apparatus 30-1 (S1106).

The first terminal apparatus 30-1 receives the ID of the distribution object, transmitted from the server 10 (S3104). The first terminal apparatus 30-1 provides the second terminal apparatus 30-2 with a uniform resource identifier (URI) for referring to the details of the distribution object, created on the basis of the ID of the distribution object (S3105).

In addition to the URI, the first terminal apparatus 30-1 may also provide the second terminal apparatus 30-2 with information on the access token T2 for updating the details of the distribution object.

The above is exemplary processing regarding creation of a distribution object.

### 3.2. Distribution Object Content Displaying Process

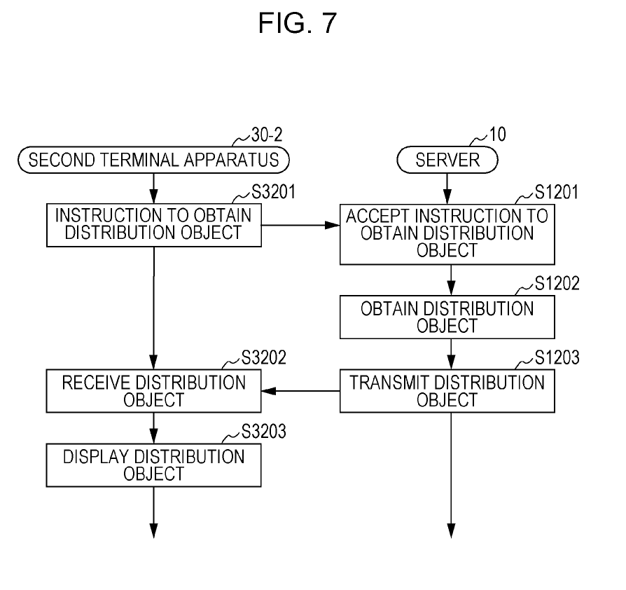

Next, on the basis of the sequence diagram illustrated in FIG. 7, an example of a process of displaying, by the second terminal apparatus 30-2, the content of the distribution object, which is executed by the second terminal apparatus 30-2 and the server 10, will be described. In the following exemplary sequence, the second terminal apparatus 30-2 has an access token t defining the scope of approval of referring to the distribution object.

Using the access token t, the second terminal apparatus 30-2 gives an instruction to the server 10 to access the URI for referring to the details of the distribution object, and to obtain information on the distribution object (S3201).

Upon acceptance of the instruction from the second terminal apparatus 30-2 to obtain information on the distribution object (S1201), the server 10 verifies the access token t, and, in the case of a successful verification, obtains information on the distribution object (S1202). For example, in the case where a type property and an etag property are not set for the distribution object, the server 10 sets, as a type property and an etag property of the distribution object, a type property and an etag property of the master data, which is the parent of the distribution object, and then obtains information on the distribution object.

The server 10 transmits the obtained information on the distribution object to the second terminal apparatus 30-2 (S1203).

The second terminal apparatus 30-2 receives the information on the distribution object from the server 10 (S3202), and, on the basis of the received information on the distribution object, displays the information on the distribution object (S3203).

The above is an example of a distribution object displaying process.

### 3.3. Distribution Object Invalidating Process (1)

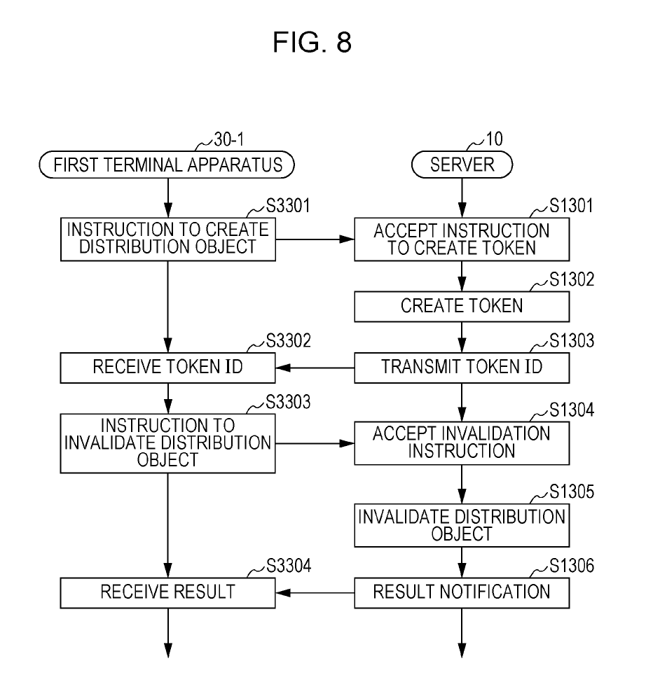

Next, on the basis of the sequence diagram illustrated in FIG. 8, an example of a distribution object invalidating process executed by the first terminal apparatus 30-1 and the server 10 will be described. The following exemplary sequence corresponds to an example in which the owner of the master data (content owner) gives an invalidation property to the distribution object, thereby invalidating the distribution object.

As illustrated in FIG. 8, using the access token T2, the first terminal apparatus 30-1 gives an instruction to the server 10 to create an access token T3 (child Content Token) for updating a property of the distribution object (S3301).

Upon acceptance of the instruction to create the access token T3 (S1301), the server 10 verifies the access token T2, and, in the case of a successful verification, creates the access token T3 (S1302). The server 10 transmits the ID (object ID) of the created access token T3 to the first terminal apparatus 30-1 (S1303).

Upon receipt of the ID of the access token T3 from the server 10 (S3302), the first terminal apparatus 30-1 transmits, using the access token T3, an instruction to the server 10 to give an invalidation property to the distribution object (S3303).

Upon acceptance of the instruction to give an invalidation property to the distribution object (S1304), the server 10 verifies the access token T3, and, in the case of a successful verification, gives an invalidation property to the distribution object (S1305). For example, the server 10 may perform the above-described invalidation process by updating information of the validity flag of the distribution object to F.

The server 10 transmits the invalidation process result to the first terminal apparatus 30-1 (S1306).

The first terminal apparatus 30-1 receives the invalidation process result from the server 10 (S3304). The above is a first example of a distribution object invalidating process.

In the case of re-validating the distribution object in the above case, it is only necessary to delete the invalidation property of the distribution object (that is, to update the information of the validity flag to T).

### 3.4. Distribution Object Invalidating Process (2)

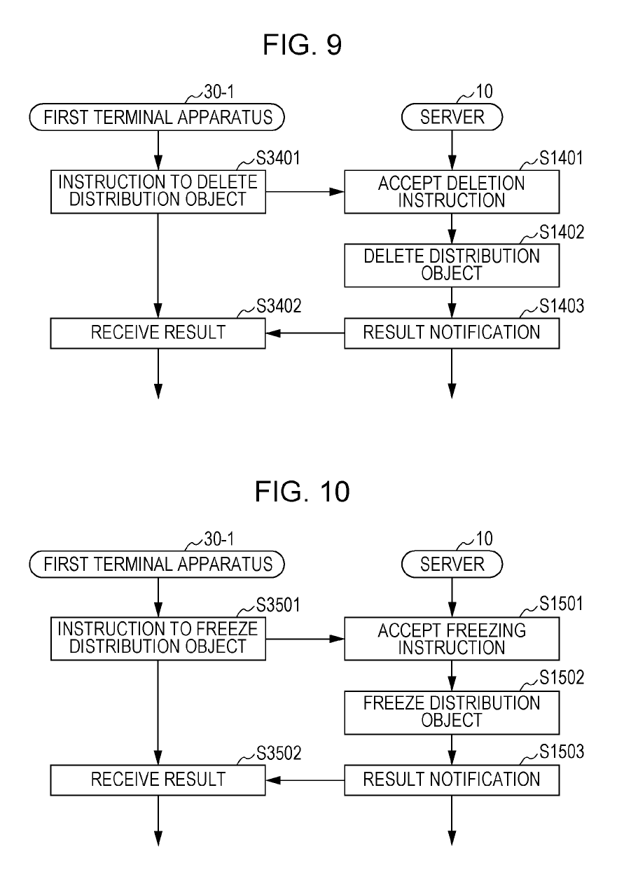

Next, on the basis of the sequence diagram illustrated in FIG. 9, a second example of a distribution object invalidating process executed by the first terminal apparatus 30-1 and the server 10 will be described. In the following exemplary sequence, invalidation of the distribution object is executed by deleting the distribution object.

Using the access token T2, the first terminal apparatus 30-1 transmits an instruction to the server 10 to delete the distribution object (S3401).

Upon acceptance of the instruction to delete the distribution object (S1401), the server 10 verifies the access token T2, and, in the case of a successful verification, deletes the distribution object (S1402). The server 10 transmits the deletion process result to the first terminal apparatus 30-1 (S1403).

The first terminal apparatus 30-1 receives the deletion process result from the server 10 (S3402). The above is the second example of a distribution object invalidating process.

### 3.5. Distribution Object Freezing Process

Next, on the basis of the sequence diagram illustrated in FIG. 10, a distribution object freezing process executed by the first terminal apparatus 30-1 and the server 10 will be described. Note that the freezing process refers to a process of ending continuous reference to the master data of the distribution object at a predetermined point of time (such as the end of a service contract), and, at that point of time, fixing the information on the distribution object.

Using the access token T3, the first terminal apparatus 30-1 transmits an instruction to the server 10 to freeze the distribution object (S3501).

Upon acceptance of the instruction to freeze the distribution object (S1501), the server 10 verifies the access token T3, and, in the case of a successful verification, freezes the distribution object (S1502). For example, the server 10 sets the etag property of the master data at the point of time at which the freezing instruction has been accepted, to the etag property of the distribution object. In doing so, even when the master data is updated thereafter, the content of the distribution object is fixed to the details of the master data at the point of time at which the freezing instruction has been accepted. The type property of the distribution object need not be updated.

The server 10 transmits the freezing process result to the first terminal apparatus 30-1 (S1503).

The first terminal apparatus 30-1 receives the freezing process result from the server 10 (S3502). The above is an example of a distribution object freezing process.

In the case of canceling the freezing of the distribution object in the above case, it is only necessary to delete the value of the etag property of the distribution object. In doing so, reference to the master data, which is the parent object of the distribution object, is recovered.

### 3.6. Process of Adding Arbitrary Function (e.g., Authentication) to Distribution Object

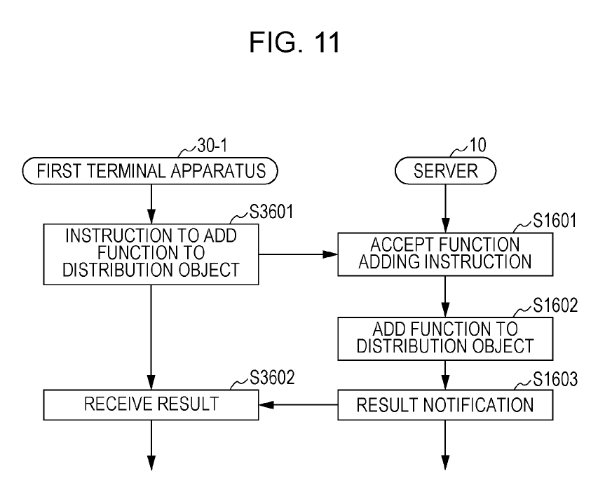

Next, on the basis of the sequence diagram illustrated in FIG. 11, an example of a process of adding an arbitrary function to the distribution object, executed by the first terminal apparatus 30-1 and the server 10, will be described. In the following exemplary sequence, it is assumed that a function for performing an authentication process in the authentication apparatus 50 at the time of accessing the distribution object is to be added.

Using the access token T3, the first terminal apparatus 30-1 transmits an instruction to the server 10 to add a function to the distribution object (S3601).

Upon acceptance of the instruction to add a function to the distribution object (S1601), the server 10 verifies the access token T3, and, in the case of a successful verification, adds a designated function to the distribution object (S1602). For example, the designated function returns true or false indicating whether authentication in the authentication apparatus 50 is successful or not.

The server 10 transmits the adding process result to the first terminal apparatus 30-1 (S1603).

The first terminal apparatus 30-1 receives the adding process result from the server 10 (S3602). The above is an example of a process of adding a function to the distribution object.

Note that the function to be added to the distribution object is not limited to the above-described authentication process. For example, a function of notifying the content owner of, in the case where the distribution object is referred to, the fact that the reference has been made may be added to the distribution object.

3.7. Process of Displaying Content of Distribution Object to which Authentication is Added

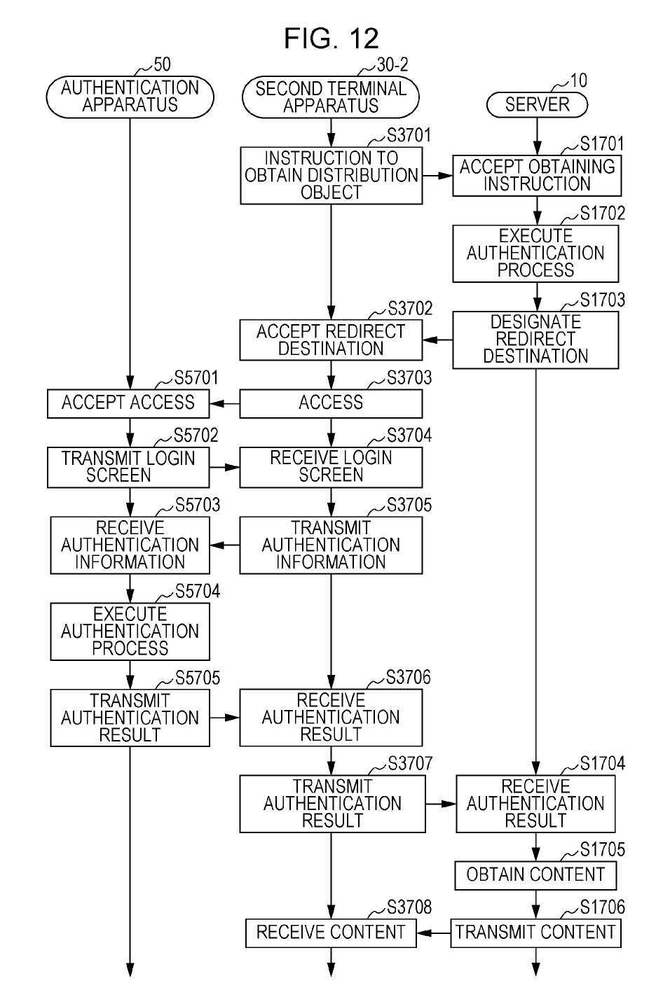

Next, on the basis of the sequence diagram illustrated in FIG. 12, an example of a process executed at the time the distribution object, to which authentication has been added, is displayed by the second terminal apparatus 30-2 will be described. The exemplary sequence described below corresponds to the case in which authentication by the authentication apparatus 50 has not been done.

Using the access token t, the second terminal apparatus 30-2 gives an instruction to the server 10 to access the URI for referring to the details of the distribution object, and to obtain information on the distribution object (S3701).

Upon acceptance of the instruction from the second terminal apparatus 30-2 to obtain information on the distribution object (S1701), the server 10 verifies the access token t, and, in the case of a successful verification, executes the added authentication function (S1702). The server 10 instructs the second terminal apparatus 30-2 that the authentication apparatus 50, which is the authentication destination, serves as a redirect destination (S1703).

Upon receipt of the redirect destination from the server 10 (S3702), the second terminal apparatus 30-2 accesses the authentication apparatus 50, which is the redirect destination (S3703).

Upon acceptance of the access from the second terminal apparatus 30-2 (S5701), the authentication apparatus 50 transmits a login screen to the second terminal apparatus 30-2 (S5702).

Upon receipt of the login screen from the authentication apparatus 50 (S3704), the second terminal apparatus 30-2 displays the received login screen, and accepts an entry of authentication information from the user. Upon acceptance of the entry of authentication information, the second terminal apparatus 30-2 transmits the accepted authentication information to the authentication apparatus 50 (S3705).

Upon receipt of the authentication information from the second terminal apparatus 30-2 (S5703), the authentication apparatus 50 executes an authentication process based on the received authentication information (S5704). The authentication apparatus 50 transmits the authentication process result (whether the authentication is successful or failed) to the second terminal apparatus 30-2 (S5705).

The second terminal apparatus 30-2 receives the authentication process result from the authentication apparatus 50 (S3706), and transmits the received authentication process result to the server 10 (S3707).

The server 10 receives the authentication process result from the second terminal apparatus 30-2 (S1704), and, in the case where the received authentication process result is successful, obtains information (content) on the distribution object (S1705).

The server 10 transmits the obtained information on the distribution object to the second terminal apparatus 30-2 (S1706).

The second terminal apparatus 30-2 receives the information on the distribution object from the server 10 (S3708), and, on the basis of the received information on the distribution object, displays the information on the distribution object.

The above is an example of a process of displaying the distribution object to which the authentication process has been added.

In the case where authentication of the second terminal apparatus 30-2 by the authentication apparatus 50 has already been done, the second terminal apparatus 30-2 may omit 53703 to 53706, and may execute 53707 after 53702.

### 4. Other Configuration Examples of Objects

The exemplary embodiment of the present invention is not limited to that described above. For example, distribution objects may be configured as follows.

### 4.1. First Exemplary Configuration

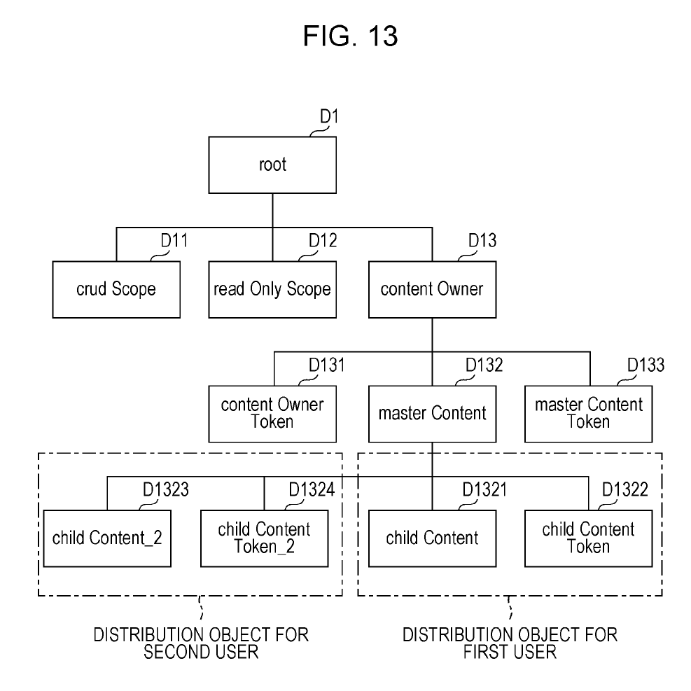

FIG. 13 illustrates an exemplary configuration of objects in the case where a distribution object is created for each distribution destination. The tree structure of objects illustrated in FIG. 13 is different from the tree structure of objects illustrated in FIG. 3 in the point that a “child Content_2” object D1323, which is a distribution object for a second user, and a “child Content Token_2” object D1324, which is for updating the “child Content_2” object D1323, are added, and is common to that in FIG. 3 in the remaining points. By creating a distribution object for each distribution destination as above, it becomes possible to provide information and to execute control with details customized for each distribution destination.

### 4.2. Second Exemplary Configuration

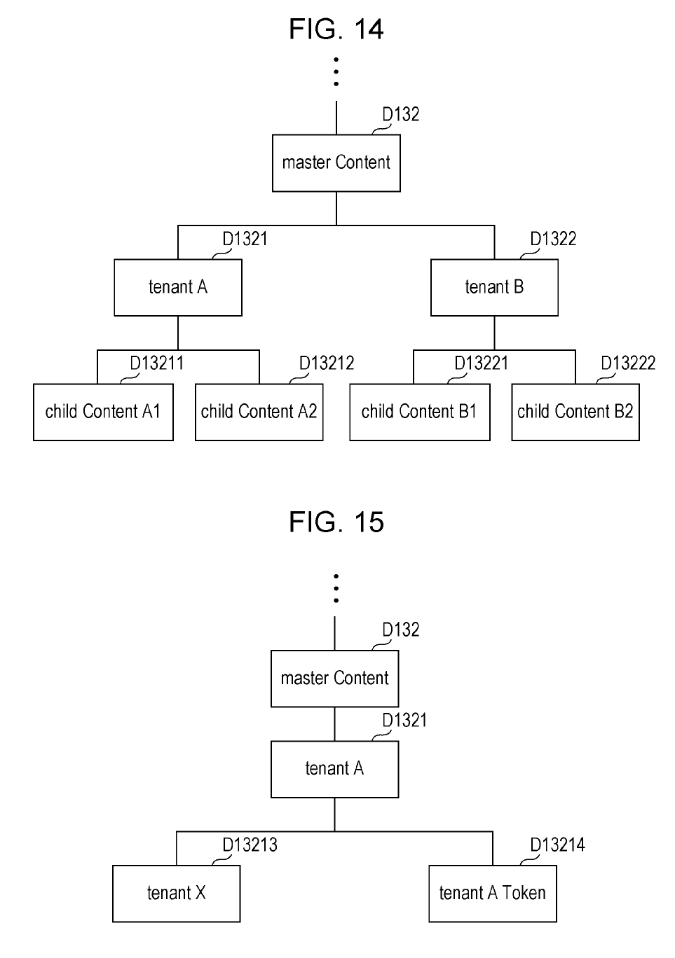

FIG. 14 illustrates an exemplary configuration of objects in the case where a child object of master data is created for each tenant (organization) to which a distribution destination belongs, and the distribution destination is constructed as a child object of the tenant. A “tenant A” D1321 and a “tenant B” D1322 are child objects of the “master Content” D132. For distribution destinations A1 and A2 belonging to “tenant A”, a “child Content A1” D13211 and a “child Content A2” D 13212, which are distribution objects, are created, respectively. Further, for distribution destinations B1 and B2 belonging to “tenant B”, a “child Content B1” D13221 and a “child Content B2” D 13222, which are distribution objects, are created, respectively.

For details that are common in the distribution destinations A1 and A2 (though these details are different from the distribution destinations B1 and B2), it is only necessary to describe the details in the “tenant A” D1321. For details that are different between the distribution destinations A1 and A2, it is only necessary to describe the details respectively in the “child Content A1” D13211 and the “child Content A2” D13212. The same applies to the distribution destinations B1 and B2.

### 4.3. Third Exemplary Configuration

FIG. 15 illustrates an exemplary configuration of objects corresponding to the case in which a tenant to which a distribution destination belongs further has a hierarchical structure. As illustrated in FIG. 15, a “tenant X” D13213 and a “tenant A Token” D13214 are created as child objects of the “tenant A” D1321. Here, the “tenant A Token” D13214 has “tenant A” as the owner, “tenant X” as the client, and the access token whose scope is CRUD. Accordingly, the tenant A is capable of creating a descendant object under “tenant A”.

The above is the illustrative examples of the configuration of objects, and, in the image processing system S according to the exemplary embodiment, it is easy to make the object configuration responsive to a target organization to which content is distributed, and it is also easy to control the details of content in such a case.

The above-described exemplary embodiment is given as specific examples, and the invention disclosed in the present specification is not construed to be limited to the configuration of these specific examples or data storage examples themselves. Those skilled in the art may make various modifications to the disclosed exemplary embodiment or make changes to, for example, the data structure or the order of executing processes. The technical scope of the invention disclosed in the present specification shall be understood to include modifications made as above.

What is claimed is:

1. An information processing system comprising:
a management unit that manages information on an object of which at least one of a parent and a child is defined;
an accepting unit that accepts a reading request for a to-be-provided object managed by the management unit, the request including designation of an authority object that is an object with which authority information is associated; and
a providing unit that provides information on the to-be-provided object, on the basis of a result of comparison of authority between an owner object that is an object approving the authority information and an object that is a parent of the authority object,
wherein the providing unit provides, for a data item not included in the to-be-provided object, information on a data item of an ancestor object included in a series that recursively traces a parent of the to-be-provided object and further a parent thereof.

2. The information processing system according to claim 1,
wherein, among items included in the ancestor object, for an item that matches an item included in the to-be-provided object, the providing unit provides information on the item included in the to-be-provided object.

3. The information processing system according to claim 1, further comprising:
a creating unit that creates, upon acceptance, by the accepting unit, of a request for creating a child object of the ancestor object, the request including designation of an authority object that is an object with which authority information is associated, the to-be-provided object as a child object of the ancestor object, on the basis of a result of comparison of authority between an owner object that is an object approving the authority information and an object that is a parent of the authority object.

4. The information processing system according to claim 1, further comprising:
an invalidating unit that invalidates, on the basis of a first authority object that has authority to create a to-be-provided object that becomes a child of the ancestor object or a second authority object that has authority to update the to-be-provided object, the to-be-provided object.

5. The information processing system according to claim 1,
wherein, upon acceptance of an instruction to freeze updating of information on the to-be-provided object, information on the to-be-provided object is fixed to information at a point of time at which the freezing instruction has been accepted.

6. The information processing system according to claim 5,
wherein, upon acceptance of an instruction to cancel the freezing after the freezing instruction has been accepted, information on the to-be-provided object is updated on the basis of information on the ancestor object.

7. The information processing system according to claim 4, further comprising:
an adding unit that adds a process to the to-be-provided object, on the basis of the second authority object.

8. The information processing system according to claim 1,
wherein the creating unit creates, for each of a plurality of providing destinations, a to-be-provided object that is a child of the ancestor object.

9. The information processing system according to claim 4,
wherein the providing unit provides information on the to-be-provided object, and the second authority object to a providing destination.

10. The information processing system according to claim 3,
wherein the creating unit creates the to-be-provided object in a case where an object that is a parent of the first authority object is included in a path that sequentially connects an object that is a parent of an owner object of the first authority object and further an object that is a parent of the parent of the owner object.

11. The information processing system according to claim 3,
wherein the creating unit does not create the to-be-provided object in a case where the first authority object is not managed by the management unit.

12. The information processing system according to claim 1,
wherein the providing unit provides information on the to-be-provided object in a case where an owner object that is an object approving the authority information matches an object that is a parent of the authority object.

13. The information processing system according to claim 1,
wherein the providing unit provides information on the to-be-provided object in a case where an object that is a parent of the authority object is included in a path that sequentially connects an owner object that is an object approving the authority information, and further a parent of a parent of the owner object.

14. An information processing method comprising:
managing information on an object of which at least one of a parent and a child is defined;
accepting a reading request for a to-be-provided object being managed, the request including designation of an authority object that is an object with which authority information is associated; and
providing information on the to-be-provided object, on the basis of a result of comparison of authority between an owner object that is an object approving the authority information and an object that is a parent of the authority object,
wherein the providing provides, for a data item not included in the to-be-provided object, information on a data item of an ancestor object included in a series that recursively traces a parent of the to-be-provided object and further a parent thereof.

15. A non-transitory computer readable medium storing a program causing a computer to execute a process, the process comprising:
accepting a reading request for a to-be-provided object being managed, the request including designation of an authority object that is an object with which authority information is associated; and
providing information on the to-be-provided object, on the basis of a result of comparison of authority between an owner object that is an object approving the authority information and an object that is a parent of the authority object,
wherein the providing provides, for a data item not included in the to-be-provided object, information on a data item of an ancestor object included in a series that recursively traces a parent of the to-be-provided object and further a parent thereof.
